(19) United States
(12) Patent Application Publication
(10) Pub. No.: US 2025/0372749 A1
(43) Pub. Date: Dec. 4, 2025

(54) SOLID-STATE BATTERY AND METHOD OF RECYCLING SOLID-STATE BATTERY

(71) Applicant: TOYOTA JIDOSHA KABUSHIKI KAISHA, Aichi-ken (JP)

(72) Inventors: Yuki SATO, Nagakute-shi (JP); Hideyuki TOKIOKA, Toyota-shi (JP); Ryuto SAKAMOTO, Okazaki-shi (JP); Kenichi KAKISHITA, Nagoya-shi (JP)

(21) Appl. No.: 19/208,585

(22) Filed: May 15, 2025

(30) Foreign Application Priority Data
May 31, 2024 (JP) 2024-089387

(51) Int. Cl. H01M 10/54; H01M 10/0585; H01M 50/46

(52) U.S. Cl. CPC H01M 10/54; H01M 10/0585; H01M 50/46

(57) ABSTRACT

A solid-state battery includes two or more stacked battery units. Each battery unit includes a first current collector, a first active material layer, a solid electrolyte layer, a second active material layer, a second current collector, a second active material layer, a solid electrolyte layer, a first active material layer, and a first current collector, which are stacked in this order. The two or more stacked battery units include an adhesive portion that adheres first current collectors opposed to each other in a stacking direction between adjacent battery units. A peel strength of the adhesive portion is less than a peel strength in the battery unit.

### CROSS-REFERENCE TO RELATED APPLICATION

This application is based on and claims priority under 35 USC 119 from Japanese Patent Application No. 2024-089387 filed on May 31, 2024, the disclosure of which is incorporated by reference herein.

### BACKGROUND

### Technical Field

The present disclosure relates to a solid-state battery and a method of recycling a solid-state battery.

### Related Art

For example, Japanese Patent Application Laid-Open (JP-A) 2017-204377 has attracted attention to a solid-state battery in which an electrolytic solution in a liquid-based secondary battery is replaced with a solid electrolyte.

Japanese Patent Application Laid-Open (JP-A) 2017-204377 describes a solid-state battery including two or more stacked battery units, each battery unit including a current collector of a first electrode, an active material layer of a first electrode, a solid electrolyte layer, an active material layer of a second electrode, a current collector of a second electrode, an active material layer of a second electrode, a solid electrolyte layer, and an active material layer of a first electrode which are stacked in this order. In this solid-state battery, first current collectors opposed to each other in a stacking direction between adjacent battery units are adhered by an adhesive means.

In recent years, due to the increased awareness of environmental problems, secondary batteries have also been required to have recyclability. In a solid-state battery in which two or more battery units are stacked as in the technology disclosed in Japanese Patent Application Laid-Open (JP-A) 2017-204377, it is considered that recyclability can be improved by enabling replacement of a battery unit in which battery performance has deteriorated.

In this case, it is desirable that the battery units adhered by the adhesive means be separated in a recyclable state. However, due to stress at the time of separation, in a case in which the first current collector arranged at the outermost layer is damaged or in a case in which each layer in the battery unit is broken, it becomes difficult to recycle and use the battery unit.

### SUMMARY

The present disclosure provides a solid-state battery capable of improving recyclability.

A solid-state battery of a first aspect includes two or more stacked battery units, each battery unit including: a first current collector; a first active material layer; a solid electrolyte layer; a second active material layer; a second current collector; a second active material layer; a solid electrolyte layer; a first active material layer; and a first current collector, which are stacked in this order, wherein the two or more stacked battery units include an adhesive portion that adheres first current collectors opposed to each other in a stacking direction between adjacent battery units, and wherein a peel strength of the adhesive portion is less than a peel strength in the battery unit.

In the solid-state battery of the first aspect, two or more battery units are stacked. In each battery unit, a first current collector, a first active material layer, a solid electrolyte layer, a second active material layer, a second current collector, a second active material layer, a solid electrolyte layer, a first active material layer, and a first current collector are stacked in this order, and a first current collector is arranged at the outermost layer.

Here, the two or more stacked battery units include an adhesive portion that adheres the first current collectors opposed to each other in the stacking direction between adjacent battery units, and the peel strength of the adhesive portion is less than the peel strength in the battery unit. Consequently, damage to the first current collector arranged at the outermost layer and breakage of each layer inside the battery unit, due to stress at the time of separating adjacent battery units from the adhesive portion, are suppressed. As a result, the adhered battery units can be separated in a recyclable state, whereby recyclability can be improved.

It should be noted that the peel strength in the battery unit here is the absolute value of the breaking stress when at least part of the first current collector, the first active material layer, the solid electrolyte layer, the second active material layer, and the second current collector configuring each layer of the battery unit is broken in a case in which stress is applied to the first current collector of the outermost layer so as to peel the first current collector from the first active material layer. Therefore, the peel strength in the battery unit can also be referred to as “the breaking strength of the battery unit”.

A solid-state battery of a second aspect is the solid-state battery of the first aspect, wherein the peel strength of the adhesive portion is greater than or equal to 20% and less than or equal to 73%, with respect to the peel strength in the battery unit.

In the solid-state battery of the second aspect, the peel strength of the adhesive portion is greater than or equal to 20% and less than or equal to 73%, with respect to the peel strength in the battery unit. By setting the peel strength of the adhesive portion to greater than or equal to 20% with respect to the peel strength in the battery unit, handleability at the time of manufacture is improved. Furthermore, by setting the peel strength of the adhesive portion to less than or equal to 73% with respect to the peel strength in the battery unit, the recyclability can be stably ensured in a practical battery.

A solid-state battery of a third aspect is the solid-state battery of the first aspect or the second aspect, wherein, in a case in which the two or more stacked battery units are transported at an acceleration of 1 G, the peel strength of the adhesive portion is greater than or equal to a peel strength at which peeling does not occur between the battery units.

In the solid-state battery of the third aspect, even in a case in which two or more stacked battery units are transported at an acceleration of 1 G at the time of manufacture, peeling does not occur between the battery units. For this reason, during manufacture, handling of a stack body obtained by stacking two or more battery units can be facilitated.

A solid-state battery of a fourth aspect is the solid-state battery of any one of the first aspect to the third aspect, wherein the adhesive portion includes an ethylene-vinyl acetate copolymer resin.

In the solid-state battery of the fourth aspect, since low-temperature sealing can be performed at a temperature, which is less than or equal to the deterioration temperature of the battery material, by the adhesive portion containing an ethylene-vinyl acetate copolymer resin, and water can be used as a solvent, emission of volatile organic compounds (VOCs) can be suppressed. As a result, the environmental performance of the solid-state battery can be improved.

A method of recycling a solid-state battery of a fifth aspect is a method of recycling the solid-state battery of any one of the first aspect to the fourth aspect, the method including: separating the first current collector from the adhesive portion to separate the two or more stacked battery units into individual battery units; and measuring a voltage of the separated battery units, and replacing a battery unit for which a voltage has been determined to be abnormal.

In the method of recycling a solid-state battery of the fifth aspect, the adhered battery units can be separated in a recyclable state. For this reason, a solid-state battery can be recycled by replacing a battery unit in which the battery performance has deteriorated among the two or more stacked battery units.

As described above, in the solid-state battery and the method of recycling a solid-state battery according to the present disclosure, recyclability can be improved.

### BRIEF DESCRIPTION OF THE DRAWINGS

Exemplary embodiments of the present invention will be described in detail based on the following figures, wherein:

FIG. 1A is a plan view, as seen from a stacking direction of an electrode body, which schematically illustrates a solid-state battery according to an exemplary embodiment;

FIG. 1B is a side view, as seen from a second width direction of the electrode body, which schematically illustrates a solid-state battery according to an exemplary embodiment;

FIG. 2 is an enlarged partial cross-sectional view illustrating, in an enlarged manner, the electrode body taken along line 2-2 of FIG. 1A;

FIG. 3A is a conceptual diagram for explaining a method of recycling a solid-state battery according to an exemplary embodiment, and illustrates a step of separating a terminal member from an electrode body;

FIG. 3B is a conceptual diagram for explaining a method of recycling a solid-state battery according to an exemplary embodiment, and illustrates a step of separating battery units from an electrode body into individual battery units;

FIG. 3C is a conceptual diagram for explaining a method of recycling a solid-state battery according to an exemplary embodiment, and illustrates a step of replacing a battery unit;

FIG. 4A is a plan view illustrating a bonded state of a measurement sample 20A and a measurement sample 20B which are used for evaluation of a peel strength of an adhesive portion;

FIG. 4B is a graph illustrating a relationship between a film thickness of an adhesive portion and a concentration of EVA in a solvent; and

FIG. 5 illustrates a relationship between a ratio of a peel strength of an adhesive portion with respect to a peel strength in a battery unit in terms of percentage, and a bonding temperature of the adhesive portion.

### DETAILED DESCRIPTION

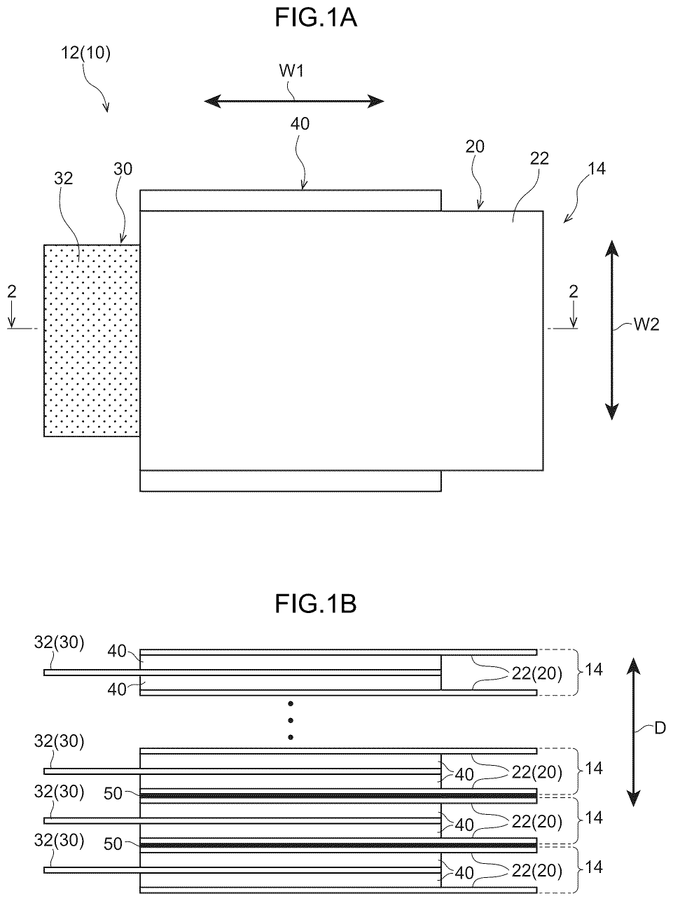

Explanation follows regarding an exemplary embodiment of a solid-state battery and a method of recycling the solid-state battery according to the present disclosure, with reference to FIG. 1A to FIG. 5. It should be noted that the solid-state battery according to the present disclosure includes so-called all-solid-state batteries in which a solid electrolyte is used as an electrolyte.

Further, unless otherwise specified in the specification, each element is not limited to one, and plural elements may be present. Moreover, in the drawings, substantially the same elements are denoted by the same reference numerals, and redundant description in the specification is omitted. In the numerical value ranges that are expressed in a stepwise manner in the specification, the upper limit value or the lower limit value described in one numerical value range may be replaced with the upper limit value or the lower limit value of another numerical value range that is expressed in a stepwise manner. Furthermore, in the numerical value ranges described in the present specification, the upper limit value or the lower limit value of a numerical range may be replaced with a value shown in the Examples.

Each component may contain plural corresponding substances. When referring to the amounts of respective components in a composition, in a case in which there are plural kinds of substances that correspond to the respective components in the composition, unless otherwise specified, the amounts of the respective components in the composition mean the total amount of the plural kinds of substances present in the composition. The term “step” includes not only an independent step, but also a step that cannot be clearly distinguished from another step as long as the intended purpose of the step is achieved.

In the solid-state battery according to the present disclosure, two or more battery units in which a first current collector, a first active material layer, a solid electrolyte layer, a second active material layer, a second current collector, a second active material layer, a solid electrolyte layer, a first active material layer, and a first current collector are stacked in this order, are stacked.

It should be noted that the first current collector and the second current collector can be a positive electrode or a negative electrode of the solid-state battery, and the first current collector and the second current collector have an opposite relationship to each other. In other words, in the case in which the first current collector is a positive electrode, the second current collector is a negative electrode. Further, in a case in which the first current collector is a negative electrode, the second current collector is a positive electrode.

Therefore, the solid-state battery according to the present disclosure may have a configuration in which two or more battery units in which a positive electrode current collector (first current collector), a positive electrode active material layer (first active material layer), a solid electrolyte layer, a negative electrode active material layer (second active material layer), a negative electrode current collector (second current collector), a negative electrode active material layer, a solid electrolyte layer, a positive electrode active material layer, and a positive electrode current collector are stacked in this order, are stacked.

Furthermore, the solid-state battery according to the present disclosure may have a configuration in which two or more battery units in which a negative electrode current collector (first current collector), a negative electrode active material layer (first active material layer), a solid electrolyte layer, a positive electrode active material layer (second active material layer), a positive electrode current collector (second current collector), a positive electrode active material layer, a solid electrolyte layer, a negative electrode active material layer, and a negative electrode current collector are stacked in this order, are stacked.

Explanation follows regarding an exemplary embodiment in which the first current collector is a positive electrode and the second current collector is a negative electrode. It should be noted that for convenience of explanation, an arrow W1 that is appropriately shown in the drawings indicates first width directions in a plan view of a solid-state battery 10, an arrow W2 indicates second width directions, which are orthogonal to the first width directions W1, in a plan view of the solid-state battery 10, and an arrow D indicates a stacking direction (thickness direction) of the solid-state battery 10.

### Main Configuration of the Solid-State Battery

FIG. 1A and FIG. 1B schematically illustrate the solid-state battery 10 according to an exemplary embodiment, FIG. 1A being a plan view of the electrode body as seen from the stacking direction D, and FIG. 1B being a side view of the electrode body as seen from the second width direction W2.

### (Electrode Body)

As illustrated in FIG. 1A and FIG. 1B, the solid-state battery 10 includes an electrode body 12 that includes a positive electrode and a negative electrode. The electrode body 12 is housed in the interior of an exterior member (not illustrated in the drawings) such as a box-shaped case or a laminate sheet.

The electrode body 12 is configured by two or more stacked battery units 14. In the electrode body 12, adjacent battery units 14 are adhered to each other via an adhesive portion 50.

The number of battery units 14 that are stacked may be two or more. For example, in the solid-state battery 10 of the present exemplary embodiment, the number of battery units 14 can be greater than or equal to 60 and less than or equal to 80.

### (Battery Unit)

The battery unit 14 includes a pair of positive electrode current collectors 20 arranged at outermost layers of the battery unit 14, one negative electrode current collector 30 arranged between the pair of positive electrode current collectors 20, and mixtures 40 arranged between the respective positive electrode current collectors 20 and the negative electrode current collector 30. Each mixture 40 includes a positive electrode active material layer 42 in one stacking direction D centering around a solid electrolyte layer 44, and a negative electrode active material layer 46 in another stacking direction D centering around the solid electrolyte layer 44. The positive electrode active material layer 42 is arranged between the positive electrode current collector 20 and the solid electrolyte layer 44. The negative electrode active material layer 46 is arranged between the negative electrode current collector 30 and the solid electrolyte layer 44.

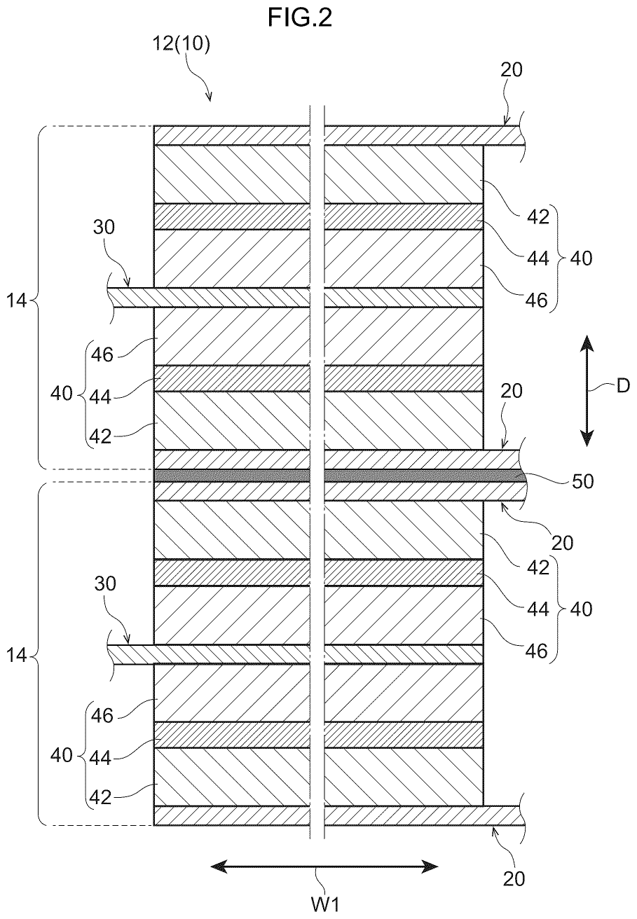

Therefore, as illustrated in FIG. 2, in the battery unit 14, a positive electrode current collector 20, a positive electrode active material layer 42, a solid electrolyte layer 44, a negative electrode active material layer 46, the negative electrode current collector 30, a negative electrode active material layer 46, a solid electrolyte layer 44, a positive electrode active material layer 42, and a positive electrode current collector 20 are stacked in this order.

### (Positive Electrode Current Collector)

The positive electrode current collector 20 collects current of a positive electrode. The positive electrode current collector 20 is arranged at a position at an opposite side to the solid electrolyte layer 44 in relation to the positive electrode active material layer 42. Examples of the positive electrode current collector 20 include stainless steel, aluminum, copper, nickel, iron, titanium, and carbon, and aluminum alloy foil or aluminum foil is preferable. The aluminum alloy foil and the aluminum foil may be manufactured using a powder. The shape of the positive electrode current collector 20 is, for example, foil-shaped or mesh-shaped.

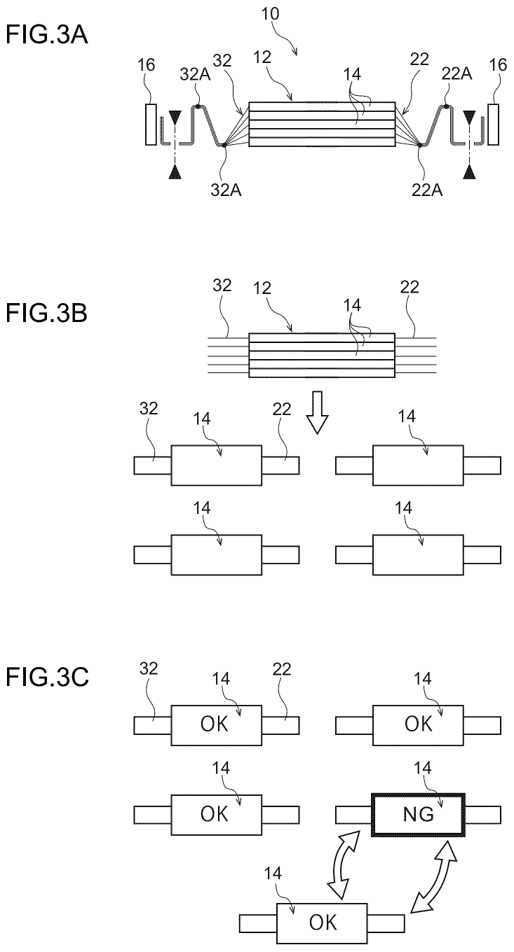

The positive electrode current collector 20 has a current collection portion 22 that is provided so as to protrude, in one of the first width directions W1, from a region overlapping with the mixture 40. The current collection portion 22 is electrically connected to a terminal member 16 at a positive electrode side (see FIG. 3A) via a current collection tab (not illustrated in the drawings). However, the current collection portion 22 may be electrically connected to the terminal member 16 without going through a current collection tab.

Furthermore, the current collection portion 22 has an extra length of a predetermined length in order to reuse what is separated from the terminal member 16 in a recycling step of the solid-state battery 10, which is described below. For this reason, the current collection portion 22 may be folded in a bellows shape so as to form plural inflection points 22A in a state in which the electrode body 12 is housed in the interior of the exterior member (see FIG. 3A).

### (Positive Electrode Active Material Layer)

The positive electrode active material layer 42 contains a positive electrode active material. The positive electrode active material layer 42 may contain at least one of a solid electrolyte for a positive electrode, a conductive auxiliary agent, or a binder, as necessary.

The positive electrode active material preferably contains a lithium composite oxide. The lithium composite oxide may contain at least one selected from the group consisting of F, CI, N, S, Br and I. Furthermore, the lithium composite oxide may have a crystal structure belonging to at least one space group selected from the space groups R-3m, Immm, and P63-mmc (also referred to as P63mc or P6/mmc). Moreover, in the lithium composite oxide, the main arrangement of the transition metal, the oxygen, and the lithium may have an O2-type structure. Examples of the conductive auxiliary agent include carbon materials, metal materials, and conductive polymer materials. Examples of the carbon materials include carbon black (for example, acetylene black, furnace black, Ketjen black, and the like), fibrous carbon (for example, vapor grown carbon fibers, carbon nanotubes, carbon nanofibers, and the like), graphite, and carbon fluoride. Examples of the metal materials include metal powders (for example, aluminum powder and the like), conductive whiskers (for example, zinc oxide, potassium titanate, and the like), and conductive metal oxides (for example, titanium oxide, and the like). Examples of the conductive polymer materials include polyaniline, polypyrrol, polythiophene, and the like. Only one type of conductive auxiliary agent may be used alone, or two or more types thereof may be mixed and used. The solid electrolyte for a positive electrode preferably contains at least one solid electrolyte selected from the solid electrolyte group consisting of sulfide solid electrolytes, oxide solid electrolytes, and halide solid electrolytes. As specific examples of the sulfide solid electrolyte, the oxide solid electrolyte, and the halide solid electrolyte, the same ones as those described below apply. Examples of the binder include vinyl halide resins, rubbers, and polyolefin resins. Examples of the other components include oxide solid electrolytes, halide solid electrolytes, thickeners, surfactants, dispersants, wetting agents, antifoaming agents, and solvents.

### (Negative Electrode Current Collector)

The negative electrode current collector 30 collects current of a negative electrode. The negative electrode current collector 30 is arranged at a position at an opposite side to the solid electrolyte layer 44 in relation to the negative electrode active material layer 46. Examples of the negative electrode current collector 30 include stainless steel, aluminum, copper, nickel, iron, titanium, and carbon, and copper is preferable. The shape of the negative electrode current collector 30 is, for example, foil-shaped or mesh-shaped.

The negative electrode current collector 30 includes a current collection portion 32 that is provided so as to protrude, in another of the first width directions W1, from a region overlapping with the mixture 40. The current collection portion 32 is electrically connected to the terminal member 16 at a negative electrode side (see FIG. 3A) via a current collection tab (not illustrated in the drawings). However, the current collection portion 32 may be electrically connected to the terminal member 16 without going through a current collection tab.

Furthermore, similarly to the current collection portion 22 at the positive electrode side, the current collection portion 32 may be folded in a bellows shape so as to form plural inflection points 32A in a state in which the electrode body 12 is housed in the interior of the exterior member (see FIG. 3A).

### (Negative Electrode Active Material Layer)

The negative electrode active material layer 46 contains a negative electrode active material. The negative electrode active material layer 46 may contain at least one of a solid electrolyte for a negative electrode, a conductive auxiliary agent, or a binder, as necessary. Examples of the negative electrode active material include Li-based active materials such as metallic lithium, carbon-based active materials such as graphite, oxide-based active materials such as lithium titanate, and Si-based active materials such as Si alone. Examples of the conductive auxiliary agent, the solid electrolyte for a negative electrode, and the binder used for the negative electrode active material layer include the same as those exemplified as the conductive auxiliary agent contained in the positive electrode active material layer, the solid electrolyte contained in the solid electrolyte layer, and the binder.

### (Solid Electrolyte Layer)

The solid electrolyte layer 44 contains a solid electrolyte. The solid electrolyte preferably contains one selected from the group consisting of sulfide solid electrolytes, oxide solid electrolytes, and halide solid electrolytes. Furthermore, the solid electrolyte may contain less than 10% by mass of an electrolytic solution based on a total amount of the electrolyte. It should be noted that the solid electrolyte may be a composite solid electrolyte containing an inorganic solid electrolyte and a polymer electrolyte.

The sulfide solid electrolyte contains sulfur(S) as the main component of an anionic element, and further, for example, preferably contains Li and element A. The element A is at least one selected from the group consisting of P, As, Sb, Si, Ge, Sn, B, Al, Ga and In. The oxide solid electrolyte contains oxygen (O) as the main component of an anionic element, and for example, may contain Li and clement Q (Q representing at least one of Nb, B, Al, Si, P, Ti, Zr, Mo, W or S). As the halide solid electrolyte, a solid electrolyte containing Li, M, and X (M representing at least one of Ti, Al or Y, and X representing F, Cl or Br) is preferred.

The solid electrolyte layer 44 may contain a binder, or may not contain a binder. Examples of the binder that can be contained in the solid electrolyte layer 44 include vinyl halide resins, rubbers, and polyolefin resins. Examples of the vinyl halide resins include polyvinylidene fluoride (PVdF), and copolymers of polyvinylidene fluoride and hexafluoropropylene (PVdF-HFP). Examples of the polyolefin resins include butadiene rubber (BR), acrylate-butadiene rubber (ABR), styrene-butadiene rubber (SBR), acrylonitrile-butadiene rubber (NBR), and butyl rubber (isobutylene-isoprene rubber). Examples of the polyolefin resins include polyethylene and polypropylene. The binder may be a diene-based rubber containing a double bond in the main chain, for example, a butadiene-based rubber in which butadiene accounts for greater than or equal to 30 mol % of the total.

### (Adhesive Portion)

As illustrated in FIG. 2, in the electrode body 12, two adjacent battery units 14 are adhered to each other via the adhesive portion 50. More specifically, in the electrode body 12, between two adjacent battery units 14, the positive electrode current collectors 20 arranged at the outermost layer of each battery unit 14 face each other in the stacking direction D. Therefore, the adhesive portion 50 adheres the positive electrode current collectors 20 arranged to face each other in the stacking direction D between the adjacent battery units 14.

The adhesive portion 50 preferably contains, for example, a thermoplastic resin. As the thermoplastic resin, a resin having a melting point or a softening point that is less than or equal to a deterioration temperature of the battery material is more preferred, and for example, a polyolefin-based resin can be used.

As the polyolefin-based resin, low-density polyethylene (LDPE), an ethylene-vinyl acetate copolymer resin (EVA), or the like can be used, and an ethylene-vinyl acetate copolymer resin (EVA) is more preferably used. By using an ethylene-vinyl acetate copolymer resin (EVA), low-temperature sealing can be performed at a temperature that is less than or equal to the deterioration temperature of the battery material. Furthermore, since water can be used as a solvent for the ethylene-vinyl acetate copolymer resin (EVA), emission of volatile organic compounds (VOCs) can be suppressed, whereby environmental performance can be improved.

By applying the adhesive portion 50 to the surface of the positive electrode current collector 20, stacked ing plural battery units 14, and pressurizing the obtained stack body, preferably under heating, two adjacent battery units 14 can be fixed.

The adhesive portion 50 may be applied to the entire surface of the positive electrode current collector 20 and may be configured to be interposed in a layer between two adjacent battery units 14, or may be configured to be applied only to part of the surface of the positive electrode current collector 20.

The thickness of the adhesive portion 50 is preferably thin in view of not unnecessarily making the thickness of the solid-state battery 10 in the stacking direction D thick, and can be set to be less than or equal to 5% of the thickness of the electrode body 12 in the stackling direction D. As an example, the thickness can be set in a range of from 0.3 μm to 2 μm, and more preferably from 0.5 μm to 1 μm.

Further, in the method of manufacturing the solid-state battery 10, which is described below, it is preferable that the peel strength of the adhesive portion 50 is large in terms of handling of the electrode body 12 without collapsing due to acceleration at the time of transportation, and the peel strength of the adhesive portion 50 is more preferably set to be greater than or equal to a peel strength at which peeling does not occur between the battery units 14 due to acceleration at the time of transportation.

Moreover, in the method of recycling the solid-state battery 10, which is described below, it is preferable that the peel strength of the adhesive portion 50 is small in terms of releasing adhesion between adjacent battery units 14 without breaking the battery units 14, and the peel strength of the adhesive portion 50 is more preferably set to be less than the peel strength in the battery unit 14.

It should be noted that the peel strength in the battery unit 14 refers to the absolute value of the breaking stress when at least part of the positive electrode current collector 20, the positive electrode active material layer 42, the solid electrolyte layer 44, the negative electrode active material layer 46, and the negative electrode current collector 30, which configure each layer of the battery unit 14, is broken in a case in which stress is applied to the outermost positive electrode current collector 20 so as to peel the positive electrode current collector 20 from the positive electrode active material layer 42 (the mixture 40). Therefore, the peel strength in the battery unit 14 can also be referred to as the “breaking strength of the battery unit”. Furthermore, breaking includes breaking of the positive electrode current collector 20 at the outermost layer, cracking of at least a part of each layer of the mixture 40, and a part of the mixture 40 missing due to adhesion of a part of the mixture 40 to the positive electrode current collector 20 in a case in which stress is applied so that the positive electrode current collector 20 is peeled from the mixture 40.

In the solid-state battery 10 of the present exemplary embodiment, as an example, the peel strength in the battery unit 14 is set to 0.4 N/cm.

Furthermore, in the solid-state battery 10 of the present exemplary embodiment, in a case in which the electrode body 12 is configured by a stack body of 60 battery units 14, the stress generated at the adhesive portion 50 of the electrode body 12 when the electrode body 12 is transported at an acceleration of 1 G is set to 0.08 N/cm. Specifically, when the magnitude of the stress at the time of transportation is expressed as a ratio with respect to the peel strength in the battery unit 14, the magnitude is 20% with respect to the peel strength (0.4 N/cm) in the battery unit 14.

From the above, in consideration of recyclability, the peel strength of the adhesive portion 50 can be set to less than 100% with respect to the peel strength in the battery unit 14. Further, as described in [Evaluation of the Peel Strength of the Adhesive Portion], which is described below, the peel strength of the adhesive portion 50 is more preferably set in a range of less than or equal to 72%. Moreover, in consideration of handleability at the time of manufacture, it is more preferable to set the peel strength of the adhesive portion 50 in a range of greater than or equal to 20% and less than 72% with respect to the peel strength in the battery unit 14.

It should be noted that the magnitude of the peel strength of the adhesive portion 50 may be such that adhesion between the battery units 14 is released by expansion and contraction due to charging or discharging of the solid-state battery 10.

Furthermore, the adhesive portion 50 is not limited to the above-described configuration which is applied to the surface of the positive electrode current collector 20. The adhesive portion 50 may be configured by, for example, a double-sided tape having an adhesive layer on both surfaces of a sheet-shaped base material.

### Method of Manufacturing the Solid-State Battery

A method of manufacturing the solid-state battery 10 includes, for example, the following first step to third step.

### (First Step)

The first step is a step of stacking the positive electrode current collector 20, the positive electrode active material layer 42, the solid electrolyte layer 44, the negative electrode active material layer 46, the negative electrode current collector 30, the negative electrode active material layer 46, the solid electrolyte layer 44, the positive electrode active material layer 42, and the positive electrode current collector 20 in this order to obtain the battery unit 14.

In the first step, a slurry containing a material configuring the positive electrode active material layer 42, a slurry containing a material configuring the solid electrolyte layer 44, and a slurry containing a material configuring the negative electrode active material layer 46 may be sequentially applied on the positive electrode current collector 20, and the first step may be performed by the positive electrode active material layer 42, the solid electrolyte layer 44, and the negative electrode active material layer 46 being prepared individually and stacking them on the positive electrode current collector 20.

### (Second Step)

The second step is a step of stacking two or more of the battery units 14 obtained in the first step to obtain the electrode body 12. In the second step, the two battery units 14 adjacent to each other in the stacking direction are adhered via the adhesive portion 50.

Specifically, in the second step, the adhesive portion 50 is arranged at a predetermined position of the positive electrode current collector 20 configuring an upper surface of the battery unit 14. Next, two or more battery units 14 in which the adhesive portion 50 is arranged on the positive electrode current collector 20 at the upper surface are stacked, whereby the electrode body 12 is obtained. In the present exemplary embodiment, as an example, 60 battery units 14 are stacked to form the electrode body 12. Thereafter, preferably, the stack body is pressurized under heating.

Examples of a pressurizing method to pressurize the stack body include mechanical pressurization and gas pressurization. Furthermore, the pressure at which the stack body is pressurized can be, for example, 1 MPa, and the heating temperature can be set in a range of, for example, from 20° C. to 100° C.

### (Third Step)

The third step is a step of housing the electrode body 12 obtained in the second step in an exterior member to obtain the solid-state battery 10. In this third step, the current collection portions 22 and 32 of the electrode body 12 may be made to meander in the stacking direction D and bent so as to form plural inflection points to be connected to the terminal member 16. This is covered with an exterior member such as a laminate film to obtain the solid-state battery 10.

It should be noted that in the third step, in a step of welding the terminal member 16 to the electrode body 12 and the step of covering the electrode body 12 with the exterior member, the electrode body 12 is transported to the working position of each step. As a method of transporting the electrode body 12, for example, an upper surface of the electrode body 12 is sucked by a suction-type robot arm or the like, and transported in a lifted state. The acceleration during transportation can be, for example, 1 G.

In the present exemplary embodiment, the peel strength of the adhesive portion 50 is set to be greater than or equal to the peel strength at which peeling does not occur between the battery units 14 in a case in which the electrode body 12 is transported at an acceleration of 1 G using the robot arm. As a result, the electrode body 12, as a stack body in which two or more battery units 14 are stacked, can be transported using the robot arm.

### Method of Recycling the Solid-State Battery

Explanation follows regarding an example of a method of recycling the solid-state battery 10, with reference to FIG. 3A to FIG. 3C. A method of recycling the solid-state battery 10 includes, for example, the following first step to fourth step.

### (First Step)

As illustrated in FIG. 3A, the first step is a step of releasing the connection between the current collection portions 22 and 32 of the electrode body 12 and the terminal member 16 and separating the terminal member 16 from the electrode body 12. In the first step, for example, the terminal member 16 is separated from the electrode body 12 by removing the part of the current collection portion 22 which is welded to the terminal member 16.

### (Second Step)

As illustrated in FIG. 3B, the second step is a step of separating the individual battery units 14 from the electrode body 12. Specifically, in the electrode body 12, the battery units 14 adjacent to each other in the stacking direction D are bonded to each other via the adhesive portion 50. Therefore, in the second step, by applying stress to each battery unit 14 so as to be separated from the electrode body 12, the positive electrode current collector 20 (the first current collector) of each battery unit 14 is peeled off from the adhesive portion 50, and the two or more stacked battery units 14 are separated into individual battery units. In this case, when any one of the layers of the positive electrode current collector 20, the negative electrode current collector 30, and the mixture 40 is damaged, the battery unit 14 cannot be used as a recycled article due to the decrease in battery performance.

Here, in the present exemplary embodiment, the peel strength of the adhesive portion 50 is set to be less than the peel strength in the battery unit 14. Therefore, breaking of the battery unit 14 due to the stress at the time of separating the adjacent battery units 14 from the adhesive portion 50 is suppressed, whereby each battery unit 14 can be separated in a recyclable state.

### (Third Step)

As illustrated in FIG. 3C, the third step is a step of measuring a voltage of the separated battery units 14 and replacing a battery unit 14 for which the voltage has been determined to be abnormal with a battery unit 14 for which the voltage has been determined to be normal.

### (Fourth Step)

The fourth step is a step of recycling the solid-state battery 10 in in a similar step to the step of the method of manufacturing the solid-state battery 10 described above. It should be noted that in the step of welding the terminal member 16 to the electrode body 12, the remaining extra-length portion of the current collection portions 22 and 32 of the electrode body 12 can be used as the welding allowance.

### Evaluation of the Peel Strength of the Adhesive Portion

In the solid-state battery 10 described above, the peel strength of the adhesive portion 50 that adheres the positive electrode current collectors 20 opposed to each other in the stacking direction D between adjacent battery units 14 was evaluated.

### (Method for Measuring the Peel Strength)

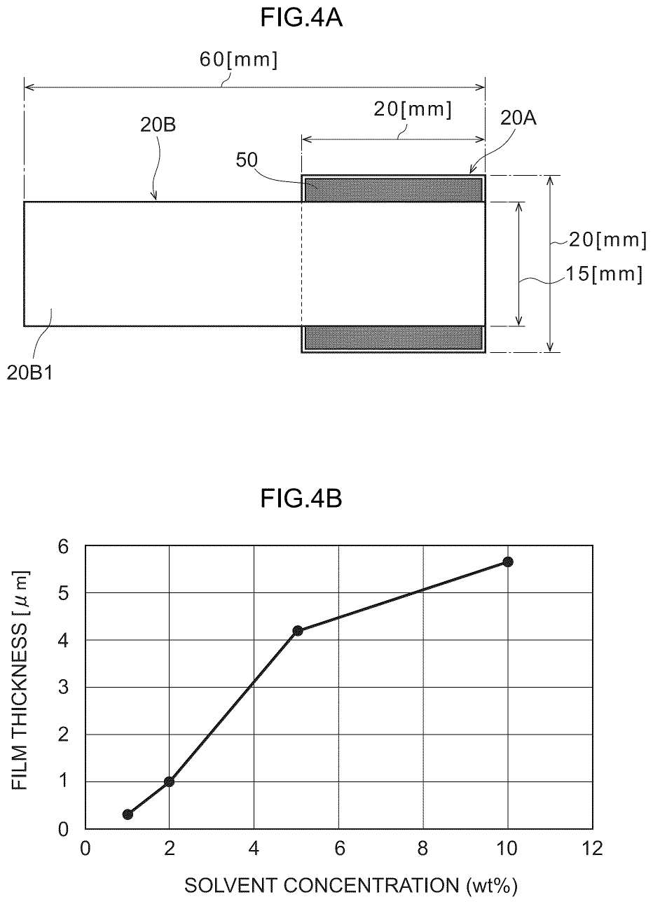

As illustrated in FIG. 4A, a measurement sample 20A having dimensions of 20 mm in length and 20 mm in width, and a measurement sample 20B having dimensions of 15 mm in length and 60 mm in width, which were cut from the positive electrode current collector 20, were bonded via the adhesive portion 50, and the peel strength of the adhesive portion 50 was measured. It should be noted that the positive electrode current collector 20 is configured here by an aluminum (Al) foil. Furthermore, the adhesive portion 50 is configured by mixing a predetermined concentration of an ethylene-vinyl acetate copolymer resin (hereinafter, simply referred to as EVA) in a solvent that is a mixture of water and isopropyl alcohol (IPA) at a ratio of 1:1, as a thermoplastic resin.

The concentration of the EVA in the solvent was determined based on the graph illustrated in FIG. 4B in consideration of the film thickness of the adhesive portion 50 when applied to the surface of the positive electrode current collector 20. In the graph illustrated in FIG. 4B, the vertical axis indicates the film thickness of the adhesive portion 50, and the horizontal axis indicates the mass percent concentration of the EVA in the solvent, and illustrates the relationship between the film thickness of the adhesive portion 50 and the concentration of the EVA in the solvent. It should be noted that the film thickness indicated in the graph was measured after coating the adhesive portion 50 on the surface of the positive electrode current collector 20 (aluminum foil) and drying it in an environment of 80° C. for 30 minutes.

As described above, the thickness of the adhesive portion 50 in the solid-state battery 10 is preferably thin in view of not unnecessarily making the thickness of the solid-state battery 10 in the stacking direction D thick, and can be set in a range of from 0.3 μm to 2 μm, and more preferably from 0.5 μm to 1 μm. Therefore, the peel strengths of the adhesive portions 50 of following Example 1 and Example 2 were measured.

### EXAMPLE 1

The concentration of the EVA in the solvent was set to 1 wt %, and the film thickness was approximately 0.5 μm.

### EXAMPLE 2

The concentration of the EVA in the solvent was set to 2 wt %, and the film thickness was approximately 1 μm.

The peel strength was measured in the following procedures (1) to (6).
(1) The surfaces of the measurement sample 20A and the measurement sample 20B were wiped with ethanol, and the oil and fat on the surfaces were removed.
(2) The adhesive portion 50 was coated on one surface of the measurement sample 20A.
(3) The one surface of the measurement sample 20A was dried in an environment of 80° C. for 30 minutes. In this step, the measurement sample 20A, which had an error with respect to a reference film thickness (0.5 μm or 1 μm) of less than a predetermined value, was used as an acceptable product in the following step.
(4) The measurement sample 20A was dried in a glove box in an environment of 40° C. for 10 hours.
(5) As illustrated in FIG. 4A, the measurement sample 20B was superimposed on the one surface (the upper surface) of the measurement sample 20A, which has been coated with the adhesive portion 50, and bonded in the glove box. Specifically, the bonding was performed by pressing under heating for 2 minutes from the upper side of the measurement sample 20B using a uniaxial press. The pressure at the time of pressurization was 1 MPa.

A sample in which the measurement sample 20A and the measurement sample 20B were bonded using the adhesive portion 50 of Example 1 was prepared in three sets for each of the cases in which the heating temperature at the time of pressing was set to 40° C., 50° C., 70° C., and 80° C.

A sample in which the measurement sample 20A and the measurement sample 20B were bonded using the adhesive portion 50 of Example 2 was prepared in three sets for each of the cases in which the heating temperature at the time of pressing was set to 25° C., 50° C., and 80° C.
(6) The lower surface of the measurement sample 20A was fixed on a stage with double-sided tape or the like, a longitudinal-direction end portion 20B1 of the measurement sample 20B was gripped, and a 90° peel test was performed to measure the peel strength.

### (Evaluation of Recyclability)

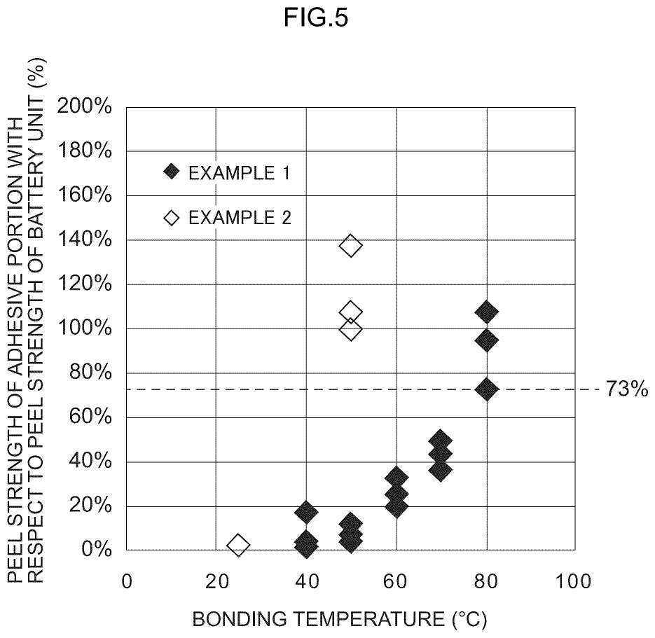

In the graph illustrated in FIG. 5, the vertical axis indicates the ratio of the peel strength of the adhesive portion 50 with respect to the peel strength in the battery unit 14 (the breaking strength of the battery unit 14), and the horizontal axis indicates the bonding temperature of the adhesive portion 50 (the heating temperature at the time of pressurization). FIG. 5 illustrates the relationship between the ratio and the bonding temperature in a case in which the peel strength of the adhesive portion 50 with respect to the peel strength in the battery unit 14 is expressed as a percentage, based on the result of the measurement of the peel strength of the adhesive portion 50 performed in the above-described procedures (1) to (6).

As described above, in consideration of the recyclability of the solid-state battery 10, the peel strength of the adhesive portion 50 can be set in a range less than the peel strength in the battery unit 14. In other words, in the graph illustrated in FIG. 5, it can be determined that a measurement sample in which the peel strength of the adhesive portion 50 is less than 100% with respect to the peel strength in the battery unit 14 is acceptable.

In Example 1, a measurement sample that was able to be determined as acceptable was obtained at all bonding temperatures (40° C., 50° C., 70° C., and 80° C.). In Example 2, in a case in which the bonding temperature was set to 25° C., a measurement sample that was able to be determined as acceptable was obtained.

Furthermore, as can be understood from FIG. 5, when the peel strength of the adhesive portion 50 was less than or equal to 73% with respect to the peel strength in the battery unit 14, recyclability can be stably ensured. Therefore, it is more preferable as a practical battery that the peel strength of the adhesive portion 50 be set in a range of less than or equal to 73% with respect to the peel strength in the battery unit 14.

### (Evaluation of the Handleability at the Time of Manufacture)

As described above, in consideration of the handleability at the time of manufacturing the solid-state battery 10, in the graph illustrated in FIG. 5, the peel strength of the adhesive portion 50 can be set in a range of greater than or equal to 20% with respect to the peel strength in the battery unit 14.

In Example 1, in a case in which the bonding temperature was set to 60° C., 70° C., and 80° C., a measurement sample that was able to be determined as acceptable was obtained. In Example 2, although a measurement sample that was able to be determined as acceptable could not be obtained, it is expected that by adjusting the bonding temperature between 25° C. and 50° C., a measurement sample that can be determined to be acceptable can be obtained.

### (Evaluation of Robustness to Temperature Change During Charge/Discharge)

In the solid-state battery 10 according to the present exemplary embodiment, the temperature may increase up to approximately 60° C. to 80° C. during charging or discharging. Therefore, the peel strength of the adhesive portion 50 is preferably also excellent in robustness against such temperature changes of the solid-state battery 10.

In Example 1, in the measurement sample in which the bonding temperature was set to from 60° C. to 80° C., the peel strength of the adhesive portion 50 was less than 100% with respect to the peel strength in the battery unit 14, and was able to be determined as acceptable in terms of robustness.

In Example 2, in the measurement sample in which the bonding temperature was set to 50° C., a case in which the peel strength of the adhesive portion 50 exceeded 100% with respect to the peel strength in the battery unit 14 was observed. Furthermore, although not illustrated in the graph of FIG. 5, in the measurement sample in which the bonding temperature was set to 80° C., the peel strength of the adhesive portion 50 exceeded 300% with respect to the peel strength in the battery unit 14. Therefore, in Example 2, there is a possibility that the peel strength of the adhesive portion 50 changes due to the temperature increase during use of the solid-state battery 10, whereby the subsequent recyclability is impaired.

As a result, in view of the robustness of the adhesive portion 50 to changes in temperature of the solid-state battery 10, the concentration of the EVA in the solvent is preferably set to less than 2 wt %, and more preferably set to 1 wt %. Furthermore, in a case in which the concentration of the EVA in the solvent is set to less than 2 wt %, it is preferable that the film thickness of the adhesive portion 50 be less than 1 um, whereby the thickness of the solid-state battery 10 in the stacking direction D is suppressed.

What is claimed is:

1. A solid-state battery, comprising:
two or more stacked battery units, each battery unit comprising:
a first current collector;
a first active material layer;
a solid electrolyte layer;
a second active material layer;
a second current collector;
a second active material layer;
a solid electrolyte layer;
a first active material layer; and
a first current collector,
which are stacked in this order,
wherein the two or more stacked battery units include an adhesive portion that adheres first current collectors opposed to each other in a stacking direction between adjacent battery units, and
wherein a peel strength of the adhesive portion is less than a peel strength in the battery unit.

2. The solid-state battery according to claim 1, wherein the peel strength of the adhesive portion is greater than or equal to 20% and less than or equal to 73%, with respect to the peel strength in the battery unit.

3. The solid-state battery according to claim 1, wherein, in a case in which the two or more stacked battery units are transported at an acceleration of 1 G, the peel strength of the adhesive portion is greater than or equal to a peel strength at which peeling does not occur between the battery units.

4. The solid-state battery according to claim 1, wherein the adhesive portion comprises an ethylene-vinyl acetate copolymer resin.

5. A method of recycling the solid-state battery according to claim 1, the method comprising:
separating the first current collector from the adhesive portion to separate the two or more stacked battery units into individual battery units; and
measuring a voltage of the separated battery units, and replacing a battery unit for which a voltage has been determined to be abnormal.
